(19) United States
(12) Patent Application Publication
(10) Pub. No.: US 2024/0348100 A1
(43) Pub. Date: Oct. 17, 2024

(54) WIRELESS POWER TRANSFER SYSTEM

(71) Applicant: Solace Power Inc., Mount Pearl (CA)

(72) Inventors: Thomas SEARY, Mount Pearl (CA); Ahmad ALMUDALLAL, Mount Pearl (CA)

(73) Assignee: Solace Power Inc., Mount Pearl (CA)

(21) Appl. No.: 18/634,173

(22) Filed: Apr. 12, 2024

Related U.S. Application Data
(60) Provisional application No. 63/459,120, filed on Apr. 13, 2023.

(51) Int. Cl. H02J 50/12; H02J 50/40

(52) U.S. Cl. CPC H02J 50/12; H02J 50/40

(57) ABSTRACT

A wireless power transfer system is provided. The system comprises a transmitter comprising a transmitter resonator comprising a plurality of one-dimensional transmitter electrodes, and an inverter. The system further comprises a receiver comprising a receiver resonator comprising a plurality of one-dimensional receiver electrodes, and a rectifier. The inverter is electrically connected to each of the transmitter electrodes. The inverter is electrically connected at offset points on the transmitter electrodes. The rectifier is electrically connected to each of the receiver electrodes. The rectifier is electrically connected at offset points on the receiver electrodes.

### CROSS REFERENCE TO RELATED APPLICATION

This application claims the benefit of U.S. Provisional Patent Application No. 63/459,120, filed Apr. 13, 2023, the entire contents of which are incorporated herein by this reference.

### TECHNICAL FIELD

The present disclosure relates generally to wireless power transfer, and in particular, to a wireless power transfer system, transmitter and receiver of a wireless power transfer system.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

A variety of wireless power transfer systems are known. A typical wireless power transfer system includes a power source electrically connected to a wireless power transmitter, and a wireless power receiver electrically connected to a load.

In magnetic induction systems, the transmitter has a transmitter coil with a certain inductance that transfers electrical energy from the power source to the receiver, which has a receiver coil with a certain inductance. Power transfer occurs due to coupling of magnetic fields between the coils or inductors of the transmitter and receiver. The range of these magnetic induction systems is limited, and the coils or inductors of the transmitter and receiver must be tightly coupled, i.e. have a coupling factor above 0.5 and be in optimal alignment for efficient power transfer.

There also exists resonant magnetic systems in which power is transferred due to coupling of magnetic fields between the coils or inductors of the transmitter and receiver. The transmitter and receiver inductors may be loosely coupled, i.e. have a coupling factor below 0.5. However, in resonant magnetic systems the inductors are resonated using at least one capacitor. Furthermore, in resonant magnetic systems, the transmitter is self-resonant and the receiver is self-resonant. The range of power transfer in resonant magnetic systems is increased over that of magnetic induction systems and alignment issues are rectified. While electromagnetic energy is produced in magnetic induction and resonant magnetic systems, the majority of power transfer occurs via the magnetic field. Little, if any, power is transferred via electric induction or resonant electric induction.

In electrical capacitive systems, the transmitter and receiver have capacitive electrodes. Power transfer occurs due to coupling of electric fields between the capacitive electrodes of the transmitter and receiver. Similar to resonant magnetic systems, there exist resonant electric systems in which the capacitive electrodes of the transmitter and receiver are made resonant using at least one inductor. The inductor may be a coil. In resonant electric systems, the transmitter is self-resonant, and the receiver is self-resonant. Resonant electric systems have an increased range of power transfer compared to that of electric induction systems and alignment issues are rectified. While electromagnetic energy is produced in electric induction and resonant electric systems, the majority of power transfer occurs via the electric field. Little, if any, power is transferred via magnetic induction or resonant magnetic induction.

While some wireless power transfer systems are known, improvements and/or alternatives are desired.

This background serves only to set a scene to allow a person skilled in the art to better appreciate the following description. Therefore, none of the above discussion should necessarily be taken as an acknowledgement that that discussion is part of the state of the art or is common general knowledge. One or more aspects/embodiments of the disclosure may or may not address one or more of the background issues.

### SUMMARY

A wireless power transfer system may be used in a variety of applications. For example, a transmitter may be positioned on one side of a medium while a receiver is positioned on the other side of the medium. The transmitter may transfer power to the receiver through the medium. Transferring power wirelessly through a medium, such as glass, is described in applicant's own U.S. Provisional Application No. 63/434,531, the relevant portions of which are incorporated herein.

The transmitter and receiver may comprise respective resonators with each resonator comprises at least an element, i.e., a transmitter and receiver element. As described above, the transmitter and receiver elements may comprise coils and/or electrodes. The electrodes may have a variety of shapes and configurations. For example, the electrodes may be concentric as described in applicant's own U.S. Pat. No. 9,979,206, the relevant portions of which are incorporated herein. Additionally, the electrodes may be used in place of a slip ring in, for example, the aerospace sector. The electrodes may be used to power components such as sensors or heaters in place of a slip ring. A slip ring with brushed contacts may be worn by a rotating rotor thereby increasing maintenance cost and time. Replacing a slip ring with electrodes which transfer power wirelessly may reduce maintenance cost and time associated with slip ring wear.

Further, the electrodes of the transmitter and receiver resonators may take the form of elongate generally rectangular, planar plates formed of electrically conductive material. Such plates are described in applicant's own U.S. Pat. No. 10,033,225, the relevant portions of which are incorporated herein. Such plates may be useful in a variety of applications. For example, vehicle manufactures are exploring technology to power components of vehicles seats. While seat belt sensors, seat warmers, fans and other powered components on a seat may be electrically powered via a conventional power cable, the desire to move the seat may cause strain on such a cable, and increase manufacturing cost and time.

Further, with the advent of autonomous self-driving vehicles, manufacturers are reconsidering traditional vehicle seat arrangements. For example, seats may be mounted on rails that run a portion of the vehicle chassis to allow for seat repositioning with the vehicle cabin. Additionally, seats may be pivotally mounted to allow for 360 degree rotation. The aforementioned powered components on a seat may be more difficult to power via a conventional power cable given this degree of movement. Such a cable may be prone to fatigue given the strain placed on it during seat movement. Further, the cable may be accessible within the cabin making incidental damage more likely. Accordingly, alternate solutions are desired. Wireless power technology may at least mitigate some of these issues.

According to an aspect of the disclosure there is provided a wireless power transfer system comprising a transmitter comprising a plurality of one-dimensional transmitter electrodes, and an inverter; and a receiver comprising a plurality of one-dimensional receiver electrodes, and a rectifier,
the inverter electrically connected to each of the transmitter electrodes, the inverter electrically connected at offset points on the transmitter electrodes, and/or
the rectifier electrically connected to each of the receiver electrodes, the rectifier electrically connected at offset points on the receiver electrodes.

A one-dimensional electrode (transmitter or receiver) is defined as an electrode having a length that is greater than a width of the electrode by a factor of at least ten. Example electrodes may include plates, rails or other elongate members. Further example electrodes may include cylindrical rings having a circumference that is larger than width by a factor of at least ten.

As described, a wireless power transfer system may be useful in a variety of applications, e.g., powering components on a moveable seat. However, when powering components between transmitter and receiver one-dimensional electrodes, the received power at the receiver has been found to be dependent on the connection points or terminals along the electrodes to the inverter/rectifier. In particular, it has been found that the voltage of the received power signal at the receiver is at a minimum when the terminals along the transmitter electrodes are aligned with the terminals along the receiver electrodes. Further, it has been found that the variation in voltage is minimized when the distance between each terminal along the transmitter electrode and a corresponding terminal along the receiver electrode is uniform through the range of motion of the receiver electrodes.

The range of motion of the receiver electrodes is the spanned distance that the receiver electrodes may move relative to the transmitter and still overlay or be overlaid by the transmitter electrodes. In other words, the distance in one dimension through which the receiver may still extract power from the transmitter.

For example, if the transmitter comprises two transmitter electrodes, and the receiver comprises two receiver electrodes, the variation in voltage is minimized when the distance between the terminals on the first transmitter and receiver electrodes combined with the distance between the terminals on the second transmitter and receiver electrodes is constant through the range of motion of the receiver electrodes. More generally, the variation in voltage is minimized when the sum of the distances between terminals on each pair of the transmitter and receiver electrodes is constant through the range of motion of the receiver electrodes.

Accordingly, the positions at which an inverter and a rectifier are electrically connected to the respective transmitter and receiver electrodes has been found to affect the voltage received at the receiver. The positions of electrical connection may be referred to as the terminals. Positioning the terminals at alternating opposing endpoints of pairs of transmitter and receiver electrodes would ensure a constant distance through the range of motion of the receiver electrodes. For example, a first terminal for the inverter may be at a first endpoint of a first transmitter electrode, while a second terminal for the inverter may be at a second endpoint of a second transmitter electrode. The endpoints may be opposite one another, i.e., at opposite longitudinal ends of the transmitter electrodes. Similarly, a first terminal for the rectifier may be at a first endpoint of a first receiver electrode, while a second terminal for the rectifier may be at a second endpoint of a second receiver electrodes. The endpoints may be opposite one another, i.e., at opposite longitudinal ends of the receiver electrodes.

However, connecting the inverter and rectifier to the end points of the electrodes increases the length of the connecting wires. Longer wires add significant power losses and therefore reduce the power transfer efficiency, i.e., efficiency of power transferred to the receiver, and output power by the transmitter. Further, longer wires might cause electromagnetic interference (EMI) and therefore make it difficult to pass electromagnetic compatibility (EMC) testing. The EM radiation could be mitigated by using coax cable; however, this would increase costs. Accordingly, it is desirable to limit wire length, and therefore limit the distance between respective connection points to the inverter, and to the rectifier.

The described wireless power transfer system provides for inverter connections which are at offset points on the transmitter electrodes, and for rectifier connections which are at offset points on the receiver electrodes. Having such offset connections improves power transfer efficiency, specifically increasing received voltage at the receiver beyond the minimum when the connections points are all centrally located along the transmitter and receiver electrodes.

Further, having offset connections which are not at the endpoints of at least one of the transmitter and receiver electrodes reduces the negative impacts of having longer wires connecting the rectifier/inverter to the respective electrodes.

The transmitter may comprise a transmitter resonator comprising the plurality of one-dimensional transmitter electrodes. The receiver may comprise a receiver resonator comprising the plurality of one-dimensional receiver electrodes. The transmitter and/or receiver resonator may comprise other electrical components such as inductors, capacitors, diodes, etc. One or more of these components may tune the system in order to maximize power transfer between the transmitter and receiver.

The transmitter and receiver electrodes may be longitudinally parallel. The transmitter and/or receiver electrode take the form of elongate generally rectangular, planar plates formed of electrically conductive material. The receiver plates may overlay or be overlaid by the transmitter plates. The receiver plates may able to move through a range of motion through which they overlay or are overlaid by the transmitter plates. Power may be transferrable from the transmitter to the receiver through the range of motion. The receiver plates may define a plane which is parallel to a plane defined by the transmitter plates. The transmitter and receiver plates may be separated by a separation distance. The distance may be uniform.

The points on the transmitter electrodes may form a first line and the points on the receiver electrodes may form a second line. That is to say the points on the transmitter electrodes may be connected to form the first line. The first line may be a straight line. The points on the receiver electrodes may be connected to form the second line. The second line may be a straight line. The first line may have one of a positive and a negative slope. The second line may have the other of a positive and a negative slope. The slopes of the line may be opposite. The slopes may be non-zero slopes.

The points on the transmitter electrodes may be intermediate points along a length of the transmitter electrodes, i.e., not the endpoints. The points on the receiver electrodes may be at the longitudinal endpoints of the receiver electrodes.

The electrodes may be formed of electrically conductive material.

The electrodes may comprise rails or tracks.

The electrodes may be concentric electrodes.

For the purpose of the subject application, concentric is defined as at least including one of the following: one or more of electrodes of the plurality of electrodes have a common central axis, one or more of electrodes of the plurality of electrodes have a common centre of rotation, one or more of electrodes of the plurality of electrodes have a common centre of mass, one or more of electrodes of the plurality of electrodes have a common centre of volume, one or more of electrodes of the plurality of electrodes have a common centre of curvature, an outer electrode, e.g., the outermost electrode, of the plurality of electrodes circumscribes each inner electrode of the plurality of electrodes, and the shape formed by extending the periphery of an outer electrode, e.g., the outermost electrode, of the plurality of electrodes in the z-axis circumscribes each inner electrode of the plurality of electrodes. Concentric is not necessarily limited to circular electrodes.

The electrodes may be cylindrical electrodes in that they have a generally cylindrical shape.

The electrodes may comprise circular or cylindrical rings. The receiver electrodes may comprise plates, circular or cylindrical rings. The transmitter electrodes may comprise plates, circular or cylindrical rings. The receiver plates may overlay or be overlaid by the transmitter rings. The receiver rings may be able to rotate through a range of motion through which they overlay or are overlaid by the transmitter rings. Power may be transferrable from the transmitter to the receiver through the range of motion. The receiver rings may define a cylindrical surface which is concentric with a cylindrical surface defined by the transmitter rings. The transmitter and receiver rings may be separated radially by a separation distance. The distance may be uniform.

The points on the transmitter electrodes may form a first line and the points on the receiver electrodes may form a second line. That is to say the points on the transmitter electrodes may be connected to form the first line. The first line may be a straight line. The points on the receiver electrodes may be connected to form the second line. The second line may be a straight line. The first line may have one of a positive and a negative slope. The second line may have the other of a positive and a negative slope. The slopes of the lines may be opposite. The slopes may be non-zero slopes.

The points on the transmitter electrodes may be intermediate points around the circumference of the transmitter electrodes. The points on the receiver electrodes may be intermediate points around the circumference of the receiver electrodes.

The electrodes may comprise a contactless slip ring.

At least one of:
the transmitter electrodes may be concentric;
the receiver electrodes may be concentric;
the transmitter electrodes may comprise circular, cylindrical transmitter electrodes; and
the receiver electrodes may comprise circular, cylindrical receiver electrodes.

According to another aspect there is provided, a wireless power transfer system comprising a transmitter comprising a plurality of one-dimensional transmitter electrodes, and an inverter; and a receiver comprising a plurality of one-dimensional receiver electrodes, and a rectifier,
the inverter electrically connected to each of the transmitter electrodes at an inverter terminal,
the rectifier electrically connected to each of the receiver electrodes at a rectifier terminal, and
the inverter and rectifier terminals positioned along the respective electrode such that a distance between inverter and rectifier terminals on at least one pair of the transmitter and receiver electrodes is the same at two different points through the range of motion of the receiver electrodes.

According to another aspect there is provided, a wireless power transfer system comprising a transmitter comprising a plurality of one-dimensional transmitter electrodes, and an inverter; and a receiver comprising a plurality of one-dimensional receiver electrodes, and a rectifier,
the inverter electrically connected to each of the transmitter electrodes at an inverter terminal,
the rectifier electrically connected to each of the receiver electrodes at a rectifier terminal, and
the inverter and rectifier terminals positioned along the respective electrode such that a sum of distances between inverter and rectifier terminals on each pair of the transmitter and receiver electrodes is constant through the range of motion of the receiver electrodes.

According to another aspect there is provided a wireless power transfer system comprising a transmitter for wirelessly transferring power to a receiver, the transmitter comprising a plurality of one-dimensional, concentric transmitter electrodes and an inverter; and a receiver for extracting power from a field generated by a transmitter, the receiver comprising a plurality of one-dimensional, concentric receiver electrodes and a rectifier.

The transmitter and/or receiver electrodes may be cylindrical electrodes in that they have a generally cylindrical shape.

The inverter may be electrically connected to each of the transmitter electrodes. The inverter may be electrically connected at offset points on the transmitter electrodes.

The positions at which an inverter and a rectifier are electrically connected to the respective transmitter and receiver electrodes has been found to affect the voltage received at the receiver. Offsetting the terminals of the transmitter electrodes from each other, and/or offsetting the terminals of the receiver electrodes from each other, may reduce the variation in voltage received at the receiver. In general, the terminals of the transmitter electrodes should be offset in the opposite direction from the terminals of the receiver electrodes to minimize the variation in voltage. If the top transmitter terminal is offset in a counter-clockwise direction from the bottom transmitter terminal, then the top receiver terminal should be offset in a clockwise direction from the bottom receiver terminal.

The described wireless power transfer system provides for inverter connections which are at offset points on the transmitter electrodes, and for rectifier connections which are at offset points on the receiver electrodes. Having such offset connections improves power transfer efficiency, specifically increasing received voltage at the receiver beyond the minimum when the connections points are all centrally located along the transmitter and receiver electrodes.

Further, having offset connections which are not at the endpoints of at least one of the transmitter and receiver electrodes reduces the negative impacts of having longer wires connecting the rectifier/inverter to the respective electrodes. Having offset connections to the cylindrical electrodes which are offset by only a small angle reduces the voltage variation somewhat and reduces the negative impacts of having longer wires connecting the rectifier/inverter to the respective electrodes.

The range of motion of the receiver electrodes is the rotational angle that the receiver electrodes may move relative to the transmitter and still overlay or be overlaid by the transmitter electrodes. In other words, the rotation about one axis through which the receiver may still extract power from the transmitter. The described cylindrical receiver electrodes may rotate continuously about one axis while remaining overlaid on or by the transmitter electrodes.

For example, if the transmitter comprises two cylindrical transmitter electrodes, and the receiver comprises two cylindrical receiver electrodes, a voltage of power transferred from the transmitter to the receiver may be maximized when the distance between the terminals on the first transmitter and receiver electrodes combined with the distance between the terminals on the second transmitter and receiver electrodes is maximized. Furthermore, the variation in voltage may be minimized when the sum of the distances between terminals on each pair of the transmitter and receiver electrodes is constant through the range of motion of the receiver electrodes.

The transmitter may comprise a transmitter resonator comprising the plurality of one-dimensional transmitter electrodes. The receiver may comprise a receiver resonator comprising the plurality of one-dimensional receiver electrodes. The transmitter and/or receiver resonator may comprise other electrical components such as inductors, capacitors, diodes, etc. One or more of these components may tune the wireless power transfer system in order to maximize power transfer between the transmitter and receiver.

According to another aspect there is provided a transmitter for wirelessly transferring power to a receiver of a wireless power transfer system, the transmitter comprising a resonator comprising a plurality of one-dimensional electrodes, and an inverter, the inverter electrically connected to each of the electrodes, the inverter electrically connected at offset points on the electrodes.

The inverter may be electrically connected at centrally offset points on the electrodes. The points may be offset from a central axis. The central axis may be at a longitudinal midpoint of the electrodes. The electrodes may be aligned such that their midpoints are aligned.

The central axis may be defined by the plurality of electrodes. The central axis may be defined by one or more of the electrodes.

The central axis may be perpendicular to longitudinal axis of the plurality of electrodes.

The points may be offset on opposing sides of the central axis. Adjacent points, i.e., points on adjacent electrodes, may be offset on opposing sides of the central axis. The offset from the central axis may be equal. I.e., a first point on a first electrode may be +2 cm from the midpoint of the first electrode, and a second point on a second electrode may be −2 cm from the midpoint of the second electrode. The midpoints may be aligned, such that the first point is +2 cm from both midpoints in the longitudinal direction, and the second point is −2 cm from both midpoints in the longitudinal direction.

Some points may be offset on opposing sides of the central axis while at least one point may be at the midpoint of an electrode.

Two or more points may be offset in a first longitudinal direction, while two or more points are offset in a second opposite longitudinal direction. The directions may be along the electrodes.

The points may be offset from each other. The points may be spaced apart from each other between adjacent electrodes in the longitudinal direction.

The points may define terminals. Terminals of the inverter may be electrically connected to the electrodes.

The plurality of electrodes may comprise a first electrode and a second electrode. The inverter may be electrically connected at a first point on the first electrode and a second point on the second electrode.

The first and second points may be on opposite sides of a central axis of at least one of the first and second electrodes. The first and second points may be laterally offset of the central axis.

The first and second points may be equidistant from the central axis of at least one of the first and second electrodes. The first and second points may be opposite each other in the longitudinal direction.

The transmitter may further comprise a power source for providing a power signal. The power source may be electrically connected to the resonator.

The distance between offset points on different electrodes may be equal, i.e., a uniform offset. Alternatively, the distance may be changing, i.e., non-uniform.

According to another aspect there is provided a transmitter for wirelessly transferring power to a receiver of a wireless power transfer system, the transmitter comprising a resonator comprising a plurality of one-dimensional circular, cylindrical electrodes, and an inverter, the inverter electrically connected to each of the electrodes, the inverter electrically connected at offset points on the electrodes.

The inverter may be electrically connected at tangentially offset points on the cylindrical electrodes.

The points may be offset from a radial axis, where the axis is defined as the zero angle. A midpoint of an electrode may be the point where the radial axis intersects the circular electrode. The electrodes may be aligned such that their midpoints are aligned.

The radial axis may be defined by the plurality of electrodes. The radial axis may be defined by one or more of the electrodes.

The radial axis may be perpendicular to the rotational axis of the plurality of electrodes. The radial axis may be perpendicular to the tangential axis of the plurality of electrodes.

The points may be offset on opposing sides of the radial axis. Adjacent points, i.e., points on adjacent electrodes, may be offset on opposing sides of the radial axis. The offset from the radial axis may be equal, i.e., a first point on a first electrode may be 5 degrees counter-clockwise from the radial axis of the first electrode about the rotational axis, and a second point on a second electrode may be 5 degrees clockwise from the radial axis of the second electrode. This may be defined as a 10 degree offset between points. The midpoints may be aligned, such that the first point is 5 degrees counter-clockwise from both midpoints in the tangential direction, and the 5 degrees clockwise from both midpoints in the tangential direction.

Some points may be offset on opposing sides of the radial axis while at least one point may be at the midpoint of an electrode.

Two or more points may be offset in a first tangential direction, while two or more points are offset in a second opposite tangential direction. The directions may be along the electrodes.

The points may be offset from each other. The points may be spaced apart from each other between adjacent electrodes in the tangential direction.

The points may define terminals. Terminals of the inverter may be electrically connected to the electrodes.

The plurality of electrodes may comprise a first electrode and a second electrode. The inverter may be electrically connected at a first point on the first electrode and a second point on the second electrode.

The first and second points may be on opposite sides of a radial axis of at least one of the first and second electrodes. The first and second points may be laterally offset of the tangential axis.

The first and second points may be equidistant from the midpoint of at least one of the first and second electrodes. The first and second points may be opposite each other in the tangential direction.

The transmitter may further comprise a power source for providing a power signal. The power source may be electrically connected to the resonator.

The angle between offset points on different electrodes may be equal, i.e., a uniform offset. Alternatively, the angle may be changing, i.e., non-uniform.

According to another aspect there is provided a receiver for extracting power from a field generated by a transmitter of a wireless power transfer system, the receiver comprising a resonator comprising a plurality of one-dimensional electrodes, and a rectifier, the rectifier electrically connected to each of the electrodes, the rectifier electrically connected at offset points on the electrodes.

The rectifier may be electrically connected at centrally offset points on the electrodes.

The points may be offset from a central axis. The central axis may be at a longitudinal midpoint of the electrodes. The electrodes may be aligned such that their midpoints are aligned.

The central axis may be defined by the plurality of electrodes. The central axis may defined by one or more of the electrodes.

The central axis may be perpendicular to longitudinal axis of the plurality of electrodes.

The points may be offset on opposing sides of the central axis. Adjacent points, i.e., points on adjacent electrodes, may be offset on opposing sides of the central axis. The offset from the central axis may be equal. I.e., a first point on a first electrode may be +2 cm from the midpoint of the first electrode, and a second point on a second electrode may be −2 cm from the midpoint of the second electrode. The midpoints may be aligned, such that the first point is +2 cm from both midpoints in the longitudinal direction, and the second point is −2 cm from both midpoints in the longitudinal direction.

Some points may be offset on opposing sides of the central axis while at least one point may be at the midpoint of an electrode.

Two or more points may be offset in a first longitudinal direction, while two or more points are offset in a second opposite longitudinal direction. The directions may be along the electrodes.

The points may be offset from each other. The points may be spaced apart from each other between adjacent electrodes in the longitudinal direction.

The points may define terminals. Terminals of the rectifier may be electrically connected to the electrodes.

The plurality of electrodes may comprise a first electrode and a second electrode. The rectifier may be electrically connected at a first point on the first electrode and a second point on the second electrode.

The first and second points may be on opposite sides of a central axis of at least one of the first and second electrodes. The first and second points may be laterally offset of the central axis.

The first and second points may be equidistant from the central axis of at least one of the first and second electrodes. The first and second points may be opposite each other in the longitudinal direction.

The distance between offset points on different electrodes may be equal, i.e., a uniform offset. Alternatively, the distance may be changing, i.e., non-uniform.

The receiver may further comprise a load electrically connected to the resonator. The receiver may further comprise a DC/DC converter electrically connected to the resonator. The DC/DC converter may be electrically connected between the load and resonator.

According to another aspect there is provided a receiver for extracting power from a field generated by a transmitter of a wireless power transfer system, the receiver comprising a resonator comprising a plurality of one-dimensional circular, concentric cylindrical electrodes, and a rectifier, the rectifier electrically connected to each of the electrodes, the rectifier electrically connected at offset points on the electrodes.

The rectifier may be electrically connected at tangentially offset points on the electrodes.

The points may be offset from a radial axis, where the axis is defined as the zero angle. A midpoint of an electrode may be the point where the radial axis intersects the circular electrode. The electrodes may be aligned such that their midpoints are aligned. The radial axis may be defined by the plurality of electrodes. The radial axis may be defined by one or more of the electrodes. The radial axis may be perpendicular to the rotational axis of the plurality of electrodes. The radial axis may be perpendicular to the tangential axis of the plurality of electrodes.

The points may be offset on opposing sides of the radial axis. Adjacent points, i.e., points on adjacent electrodes, may be offset on opposing sides of the radial axis. The offset from the radial axis may be equal. I.e., a first point on a first electrode may be 5 degrees counter-clockwise from the radial axis of the first electrode about the rotational axis, and a second point on a second electrode may be 5 degrees clockwise from the radial axis of the second electrode. This would be defined as a 10 degree offset between points. The midpoints may be aligned, such that the first point is 5 degrees counter-clockwise from both midpoints in the tangential direction, and the 5 degrees clockwise from both midpoints in the tangential direction.

Some points may be offset on opposing sides of the radial axis while at least one point may be at the midpoint of an electrode.

Two or more points may be offset in a first tangential direction, while two or more points are offset in a second opposite tangential direction. The directions may be along the electrodes.

The points may be offset from each other. The points may be spaced apart from each other between adjacent electrodes in the tangential direction.

The points may define terminals. Terminals of the rectifier may be electrically connected to the electrodes.

The plurality of electrodes may comprise a first electrode and a second electrode. The rectifier may be electrically connected at a first point on the first electrode and a second point on the second electrode.

The first and second points may be on opposite sides of a radial axis of at least one of the first and second electrodes. The first and second points may be laterally offset of the tangential axis.

The first and second points may be equidistant from the midpoint of at least one of the first and second electrodes. The first and second points may be opposite each other in the tangential direction.

The distance between offset points on different electrodes may be equal, i.e., a uniform offset. Alternatively, the distance may be changing, i.e., non-uniform.

The receiver may further comprise a load electrically connected to the resonator. The receiver may further comprise a DC/DC converter electrically connected to the resonator. The DC/DC converter may be electrically connected between the load and resonator.

According to another aspect there is provided, a method of providing a transmitter for wirelessly transferring power to a receiver of a wireless power transfer system, the transmitter comprising a resonator comprising a plurality of one-dimensional electrodes, and an inverter, the method comprising:
electrically connecting an inverter of a transmitter to each one of a plurality of electrodes of a transmitter resonator of the transmitter, the inverter electrically connected at offset points on the electrodes.

According to another aspect there is provided, a method of providing a receiver for extracting power from a field generated by a transmitter of a wireless power transfer system, the receiver comprising a resonator comprising a plurality of one-dimensional electrodes, and a rectifier, the method comprising:
electrically connecting a rectifier of a receiver to each one of a plurality of electrodes of a receiver resonator of the receiver, the rectifier electrically connected at offset points on the electrodes.

The methods may include any of the described aspects or features described in relations to any of the aspects.

As described, the electrodes of the transmitter and receiver resonators may take the form of elongate generally rectangular, planar plates. The distance between the transmitter and receiver plates may be referred to as the separation distance. The power transferred and power transfer efficiency may be sensitive to changes in alignment between the transmitter and receiver plates, and more generally transmitter and receiver electrodes.

Furthermore, the transmitter electrodes, e.g., the transmitter plates, may not be perfectly flat along their entire length due to machining tolerances during manufacturing and/or additional support components for mounting the electrodes. Accordingly, alignment of the receiver and transmitter electrodes may be negatively impacted as the receiver electrodes moves along the transmitter electrodes. Such alignment issues may reduce power transferred and power transfer efficiency.

Elements of the transmitter and receiver may be enclosed within a housing, the housing may comprise a rail enclosure. The rail enclosure may enclose a rectifier of the receiver. The rail enclosure may further enclose the transmitter and/or receiver electrodes.

The rail enclosure may comprise a transmitter enclosure and a receiver enclosure. The transmitter enclosure may comprise a transmitter rail. The transmitter rail may form an enclosure. The transmitter rail may form the transmitter electrode. Components of the transmitter, such as an inverter, may be closed within the transmitter rail.

The receiver enclosure may comprise a receiver rail. The receiver rail may be adapted to move along a length of the transmitter rail. Specifically, the receiver rail may be adapted to slide along the transmitter rail. Power may be transferred from the transmitter to the receiver via the transmitter and receiver rails. Power may be transferred through the entire range of motion of the receiver rail along the transmitter rail.

While the disclosure has been described with reference to connections between the electrodes and inverters or rectifiers, one of skill in the art will appreciate the connections may be to other electrical components. For example, the transmitter electrodes may be electrically connected to a DC/DC converter or directly to a power source. Further, the receive electrodes may be electrically connected to a DC/DC converter or directly to a load. The points along the electrodes accordingly may therefore simply refer to connection points, and are not limited to connection points to an inverter or rectifier.

The invention includes one or more corresponding aspects, embodiments or features in isolation or in various combinations whether or not specifically stated (including claimed) in that combination or in isolation. As will be appreciated, features associated with particular recited embodiments relating to systems may be equally appropriate as features of embodiments relating specifically to methods of operation or use, and vice versa.

The above summary is intended to be merely exemplary and non-limiting.

### BRIEF DESCRIPTION OF THE DRAWINGS

These and other aspects of the present disclosure will now be described, by way of example only, with reference to the accompanying Figures, in which:

FIG. 1 is a block diagram of a wireless power transfer system;

FIG. 2 is a block diagram of a wireless power transfer system in accordance with an aspect of the disclosure;

FIG. 3 is a block diagram of a portion of the system of FIG. 2;

FIG. 4 is a graph of rectified voltage compared to receiver electrode position;

FIG. 5 is a graph of voltage at the receiver of the system of FIG. 2;

FIG. 6 is another embodiment of transmitter and receiver electrode connection points for the system of FIG. 2;

FIG. 7 is a perspective view of a rail enclosure for transmitter and receiver elements of the system of FIG. 2;

FIG. 8 is a perspective view of another embodiment of a portion of the system of FIG. 2; and

FIG. 9 is a top view of the embodiment of FIG. 8.

### DETAILED DESCRIPTION OF THE DRAWINGS

The foregoing summary, as well as the following detailed description of certain embodiments will be better understood when read in conjunction with the accompanying drawings. As will be appreciated, like reference characters are used to refer to like elements throughout the description and drawings. As used herein, an element or feature recited in the singular and preceded by the word “a” or “an” should be understood as not necessarily excluding a plural of the elements or features. Further, references to “one example” or “one embodiment” are not intended to be interpreted as excluding the existence of additional examples or embodiments that also incorporate the recited elements or features of that one example or one embodiment. Moreover, unless explicitly stated to the contrary, examples or embodiments “comprising”, “having” or “including” an element or feature or a plurality of elements or features having a particular property might further include additional elements or features not having that particular property. Also, it will be appreciated that the terms “comprises”, “has” and “includes” mean “including but not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of describing the relationship of an element or feature to another element or feature as depicted in the figures. The spatially relative terms can, however, encompass different orientations in use or operation in addition to the orientation depicted in the figures.

Reference herein to “example” means that one or more feature, structure, element, component, characteristic and/or operational step described in connection with the example is included in at least one embodiment and or implementation of the subject matter according to the present disclosure. Thus, the phrases “an example,” “another example,” and similar language throughout the present disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the element or feature to the physical characteristics of the element or feature preceding the phrase “configured to”.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the terms “approximately” and “about” represent an amount close to the stated amount that still performs the desired function or achieves the desired result. For example, the terms “approximately” and “about” may refer to an amount that is within less than 10% of, within less than 5% of, within less than 1% of, within less than 0.1% of, or within less than 0.01% of the stated amount.

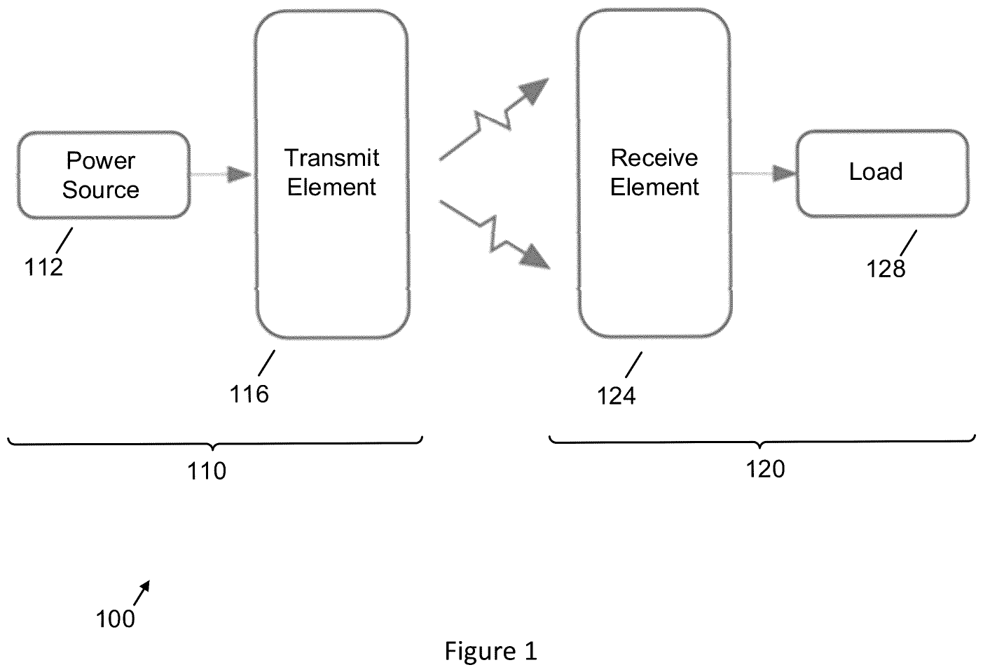

Turning now to FIG. 1, a wireless power transfer system generally identified by reference numeral 100 is shown. The wireless power transfer system 100 comprises a transmitter 110 comprising a power source 112 electrically connected to a transmitter element 116, and a receiver 120 comprising a receiver element 124 electrically connected to a load 128. Power is transferred from the power source 112 to the transmitter element 116. The power is then transferred from the transmitter element 116 to the receiver element 124 via resonant or non-resonant electric or magnetic field coupling. The power is then transferred from the receiver element 124 to the load 128. Exemplary wireless power transfer systems 100 include a high frequency inductive wireless power transfer system as described in applicant's U.S. Provisional Application No. 62/899,165, or a resonant capacitively coupled wireless power transfer system as described in applicant's U.S. Pat. No. 9,653,948B2, the relevant portions of which are incorporated herein.

In the wireless power transfer system 100, power is transferred from the transmitter element 116 to the receiver element 124. It may be desirable to be able to transfer power to and from each respective element, i.e., from receiver element 124 to transmit 116.

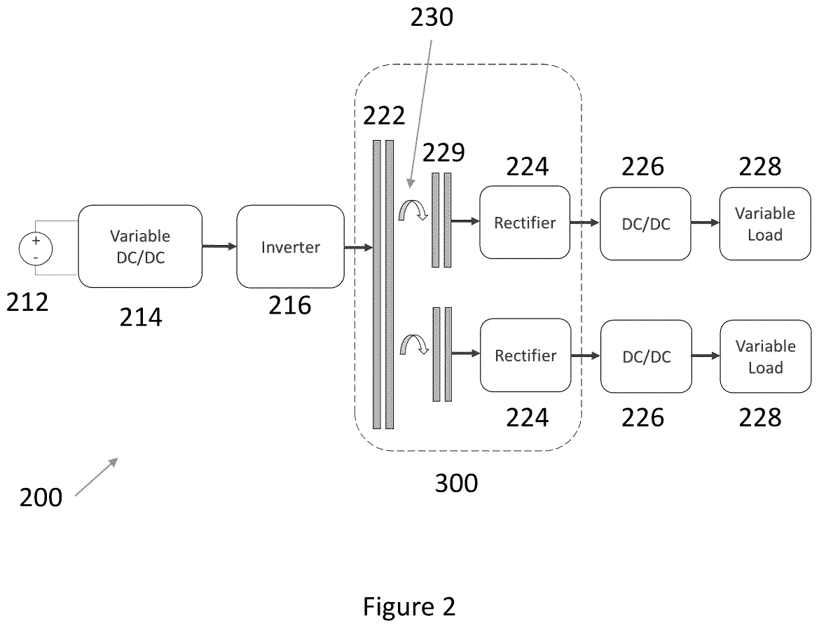

Turning now to FIG. 2, an embodiment of a wireless power transfer system 200 is shown. The system comprises a transmitter comprising a power supply 212, a DC/DC converter 214, an inverter 216 and a transmitter resonator. The transmitter resonator comprises transmitter electrodes 222.

The power source 212 is electrically connected to the DC/DC converter 214. The DC/DC converter 214 is electrically connected to the inverter 216. The inverter 216 is electrically connected to the transmitter resonator, specifically, the transmitter electrodes 222.

The power supply 212 is for generating an input power signal for transmission of power. In this embodiment, the input power signal is a direct current (DC) power signal. In the illustrated embodiment, the power supply 212 s a 24 VDC power supply.

The DC/DC converter 214 is for converting a received DC voltage signal to a desired voltage level. The received DC voltage may be from the power supply 212. The system 200 is illustrated as comprising the DC/DC converter 214, one of skill in the art will appreciate other configurations are possible. In another embodiment, no DC/DC converter is present. The DC/DC converter 214 is a variable converter although non-variable may be used.

The inverter 216 is for converting a DC signal from the DC/DC converter 214 to an AC signal.

The transmitter resonator comprises two transmitter electrodes 222 and inductive elements, i.e., inductors. The transmitter electrodes 222 are laterally spaced, elongated electrodes, e.g., planar, longitudinal, plates. The inductive elements may comprise one or more coils. The coils may include booster or shield coils such as described in applicant's U.S. patent application Ser. No. 17/193,539, the relevant portions of which are incorporated herein by reference. The transmitter resonator may further include resonator elements for resonating the transmitter electrodes 222 and inductive elements, i.e., capacitors and inductors.

The power source 212 supplies a DC input power signal to the DC/DC converter 214 which converts the signal to a desired voltage level. The inverter 216 receives the converted DC power signal and converts the DC power signal to AC to allow the transmitter elements 222 to generate an electric field at the transmitter elements 222 to transfer power via electric field coupling. While a magnetic field may be present, little, if any, power is transferred via magnetic field coupling.

The system 200 further comprises a receiver comprising a receiver resonator, a rectifier 224, a DC/DC converter 226 and a load 228. The receiver resonator comprises receiver electrodes 229. In the illustrated embodiment, the system 200 includes two receivers each having a receiver resonator, a rectifier 224, a DC/DC converter 226 and a load 228. One of skill in the art will appreciate more or less receivers may be present.

A single receiver will be described. One of skill in the art will appreciate the description applies equally to both receivers.

In the illustrated arrangement, the load 228 is a DC load. The load 228 may be static or variable. The load 228 may comprise one or more motors to move the receiver along a rail.

The DC/DC converter 226 is for converting a received DC voltage signal to a desired voltage level. The received DC voltage may be from the rectifier 224. While the system 200 comprises the DC/DC converter 226, one of skill in the art will appreciate other configurations are possible. In another embodiment, no DC/DC converter 226 is present. The DC/DC converter 226 may further step down the voltage to a regulated 12 V DC output to the load 228.

The rectifier 224 is for rectifying a received AC signal to DC for output to the converter 226. The rectifier 224 may step down a rectified voltage from the receiver elements 229 (the receiver resonator) to an unregulated DC voltage in the range of 18 to 35 V.

The receiver resonator comprises the receiver electrodes 229 and inductive elements, i.e., inductors. The receiver electrodes 229 are laterally spaced, elongate electrodes. The inductive elements may comprise one or more coils. The coils may include booster or shield coils such as described in applicant's U.S. patent application Ser. No. 17/193,539, the relevant portions of which are incorporated herein by reference.

The transmitter and receiver elements 222, 229 of the system 200 form the wireless link 230. The elements 222, 229 are separated by a wireless gap or separation distance. The wireless gap may be formed by atmosphere, i.e., air, or by a physical medium, e.g., walls, glass, liquids, wood, insulations, etc. Power is transferred from one element to the other across the wireless link 230 via resonant or non-resonant electric field coupling, i.e., electric induction.

During operation, the receiver electrodes 229 extract power from an electric field generated by the transmitter electrodes 222. The rectifier 224 rectifies the received power signal. The DC/DC converter 226 converts the rectified power signal to the desired power level which is received by the load 228. In this way, the receiver electrodes 229 extracts power transmitted by the transmitter electrodes 222 such that electrical power is transferred to the load 228 via electric field coupling. The load 228, DC/DC converter 226, rectifier 224 and receiver electrodes 229 may collectively form the receiver. As previously stated, the DC/DC converter 226 may not be present in the receiver.

The inverter 216 is electrically connected to the transmitter electrodes 222 and the rectifier 224 is electrically connected to the receiver electrodes 229. As the electrodes 222, 229 are planar plates, i.e., generally one-dimensional electrodes, a phenomenon which has been observed is a minimum received voltage (i.e., minimum power transferred from the transmitter to the receiver) when the connections between the inverter 216 are rectifier 224 are aligned. In contrast, the received voltage is at a maximum when the distance from each the connections on the transmitter electrodes 222 to the corresponding connections on the receiver electrodes 229 is uniform through the full range of motion of the receiver electrodes 229 along the transmitter electrodes 222.

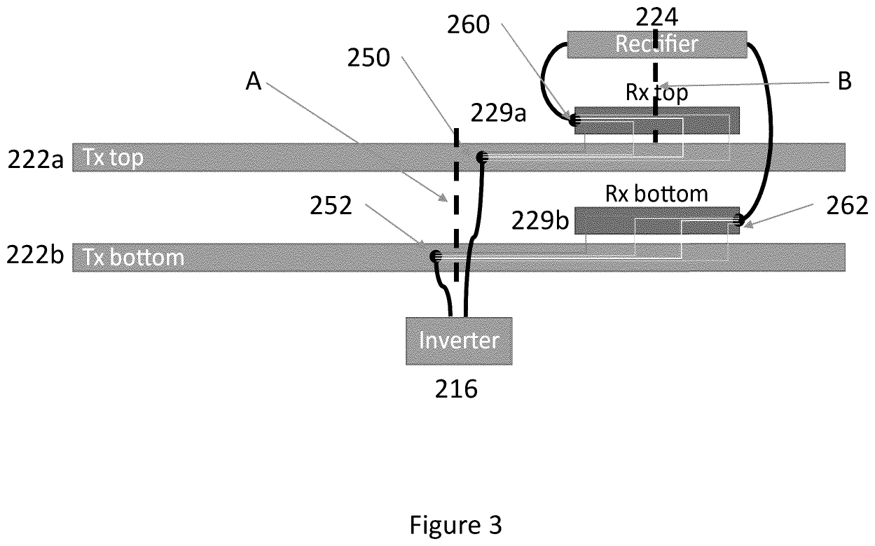

Turning now to FIG. 3, the connections between the inverter 226 and the transmitter electrodes 222, and the rectifier 224 and the receiver electrodes 229 are shown. The configuration illustrated in FIG. 3 is intended to maximize power transferred to the receiver as will be described.

Specifically, the inverter 216 of the transmitter is connected to a first transmitter electrode 222a, i.e., a top transmitter electrode, at point (terminal) 250), and to a second transmitter electrode 222b, i.e., a bottom transmitter electrode, at point (terminal) 252. The rectifier 224 of the receiver is connected to a first receiver electrode 229a, i.e., a top receiver electrode, at point (terminal) 260, and to a second receiver electrode 229b, i.e., a bottom receiver electrode, at point (terminal) 262.

The connection points 250, 252 are offset from a central axis or midpoint A of the transmitter electrodes 222a, 222b. The points 250, 252 are offset in opposite longitudinal directions along the transmitter electrodes 222a, 222b. Further, the points 250, 252 are equidistant from the central axis A. For example, connection point 250 which is the connection for a first terminal of the inverter 216 to the first transmitter electrode 222a is +6 cm from the central axis A. The connection point 252 which is a connection for the second terminal of the inverter 216 to the second transmitter electrode 222b is −6 cm from the central axis A.

Similarly, the connection points 260, 262 are offset from a central axis or midpoint B of the receiver electrodes 229a, 229b. The points 260, 262 are offset in opposite longitudinal directions along the receiver electrodes 229a, 229b. Further, the points 260, 262 are equidistant from the central axis B. For example, connection point 260 which is the connection for a first terminal of the rectifier 224 to the first receiver electrode 229a is +21 cm from the central axis B. The connection point 262 which is a connection for the second terminal of the rectifier 224 to the second receiver electrode 292b is −21 cm from the central axis B. In the illustrated arrangement, the connection points 260, 262 on the receiver electrodes 229 are at the endpoints of the electrodes 229.

As a result of this configuration, the total distance from the transmitter connection points 250, 252 to the receiver connection points 260, 262 is constant when the receiver electrodes 229 move within a 54 cm section of the transmitter electrodes 222.

While it is possible to have the connections 250, 252 on the transmitter electrodes 222 at the endpoints thereof, doing so would increase the wire length between the inverter 216 and the transmitter electrodes 222. This would add significant power losses and therefore reduce the power transfer efficiency, i.e., efficiency of power transferred to the receiver, and output power by the transmitter. Further, longer wires might cause electromagnetic interference (EMI) and therefore make it difficult to pass electromagnetic compatibility (EMC) testing. The EM radiation could be mitigated by using coax cable; however, this would increase costs. Accordingly, it is desirable to limit wire length, and therefore limit the distance between respective connection points 250, 252 to the inverter 216. The selected offset from the central axis A has been found to optimise power transfer through the greatest range of motion while minimizing wire length to the inverter 216.

Connecting the points 250, 252 forms a line having a positive slope. Connecting the points 260, 262 forms a line having a negative slope. Thus, the lines connecting the points on the transmitter electrodes and the receiver electrodes have opposite slopes.

As one of skill in the art will appreciate, the slopes could be reversed with the points on the transmitter electrodes 222 having a negative slope and the points on the receiver electrodes 229 having a positive slope.

During operation, the receiver electrodes 229 overlay the transmitter electrodes 222 and move along a path defined by the transmitter electrodes 222. Specifically, the first receiver electrode 229a overlays the first transmitter electrode 222a, and the second receiver electrode 229b overlays the second transmitter electrode 222b. Power is transferred from the transmitter electrodes 222 to the receiver electrodes 229 through the range of motion defined by the endpoints of the transmitter electrodes 229. The receiver electrodes 222 moves in union along the length of the transmitter electrodes 229.

An exemplary system 200 was simulated in order to assess the performance of the wireless power transfer. For the simulation, the transmitter electrodes 222 each have a length of 197.5 cm in the x axis. The receiver electrodes 229 have each have a length of 42 cm in the x axis. Thus, the range of motion of the receiver electrode 229 along the length of the transmitter electrodes 222 is approximately 155 cm. The separation distance of gap between the transmitter electrodes 222 and the receiver electrodes 229 is 2.5 mm in the y axis.

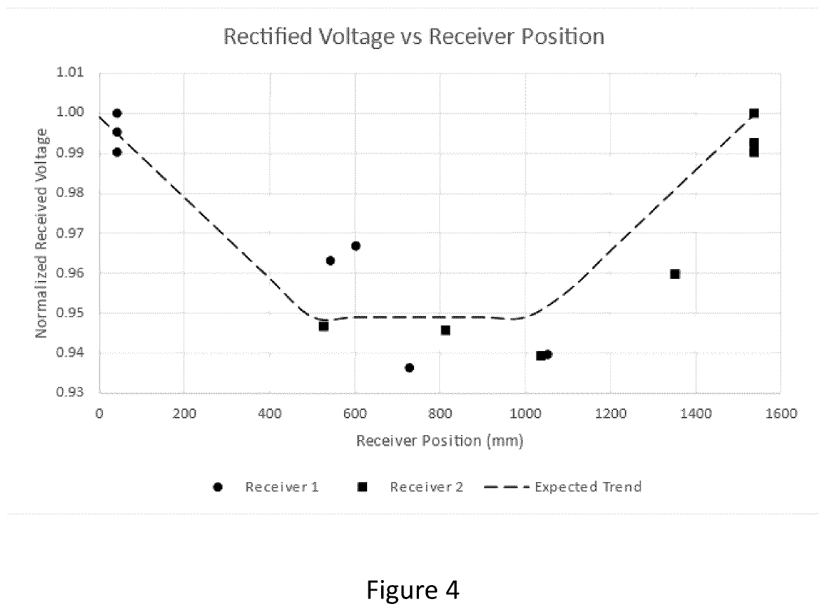

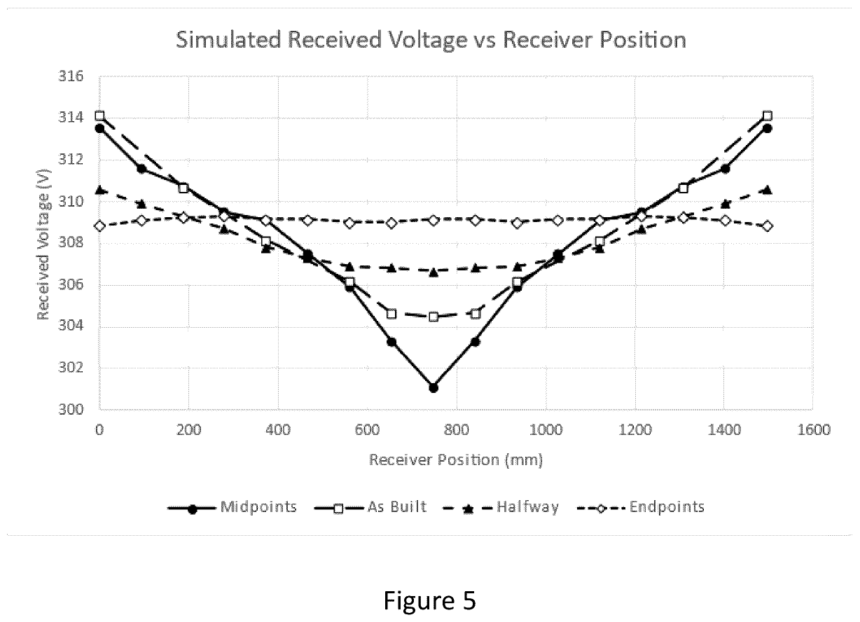

The experimental operational results of the described system are illustrated in FIG. 4. Further, FIG. 5 illustrates simulations of system operation when the terminal connections are as described compared to conventional midpoint connections. FIG. 4 is a graph of normalised rectified voltage at the receiver through a range of receiver positions along the length of the transmitter electrodes 222. The graph includes the rectified voltage at each receiver electrode 229 of the receiver. Specifically, Vrect3 is the rectified voltage at the first receiver electrode 229a and Vrect4 is the rectified voltage at the second receiver electrode 229b. The receiver electrode range in position from 0 to 1600 mm along the length of the transmitter electrodes 222. FIG. 4 includes the expected rectified voltage trend as a broken line. The expected rectified voltage trend line is based on the range of receiver electrode motion along the transmitter electrode. The flat middle portion of the trend line is 54 cm, which corresponds with the span where the offset terminal connections have an effect. Outside of this middle portion, the voltage is expected to rise as the distance between the terminal connections on the transmitter and receiver electrodes increases.

As shown in FIG. 4, the rectified voltage generally follows the expected trend. Further, the rectified voltage is just below 95% of maximum through the range of about 500 mm to about 1000 mm. Below and above this range, the rectified voltage increases to approximately 100% level.

FIG. 5 is a graph of voltage at the receiver of the system 200 through a range of receiver positions along the length of the transmitter electrodes 222. Further, FIG. 5 illustrates received voltage with terminal connections at various locations along the electrodes. The receiver ranges in position from 0 to 1500 mm along the length of the transmitter electrodes 222. The midpoint is at 750 mm. FIG. 5 illustrates received voltages at various terminal connection positions along the transmitter electrodes. The “Endpoints” curve illustrates the voltage when the connections are maximally offset. The “Midpoints” curve illustrates the voltage when the connections are at the midpoints. The “Halfway” curve illustrates the voltage when the connections are halfway between the midpoints and endpoints. The “As Built” curve illustrates the voltage in the case selected for operational use.

As shown in FIG. 5, the voltage stays relatively constant at approximately 309 V when the connections are maximally offset, at the endpoints of the transmitter electrodes 222 on the positive slope, and at the endpoints of the receiver electrodes 229 on the negative slope (“Endpoints” curve).

In contrast when the connection points are all at the midpoints of the electrodes 222, 229, i.e., on the longitudinal midpoints of the transmitter electrodes 222 and on the longitudinal midpoints of the receiver electrodes 229, the voltage is maximised at about 314 V, but drops to 301 V as the receiver electrodes 229 approach the midpoint of the transmitter electrodes 222 (“Midpoints” curve). This illustrates that connecting the rectifier 224 and inverter 216 to the electrodes 222, 229 in the manner described maintains the voltage at the receiver at a near steady state. This puts less stress on the electrical components of the receiver.

The “Halfway” and “As Built” curves represent selecting a smaller offset than the maximal endpoint offset of the “Endpoints” curve. The “Halfway” curve shows the case where the connections to the transmitter electrodes are halfway between the midpoints and the endpoints on the positive slope, and the connections to the receiver electrodes are at the endpoints on the negative slope. For this case, the received voltage is approximately constant for receiver positions 500 mm and 1000 mm. The “As Built” curve shows the simulated behaviour of the system when the transmitter terminals are placed 12 cm apart on the positive slope, and the receiver terminals are placed and the endpoints on the negative slope. This case can be compared to the experimental measurements of FIG. 4.

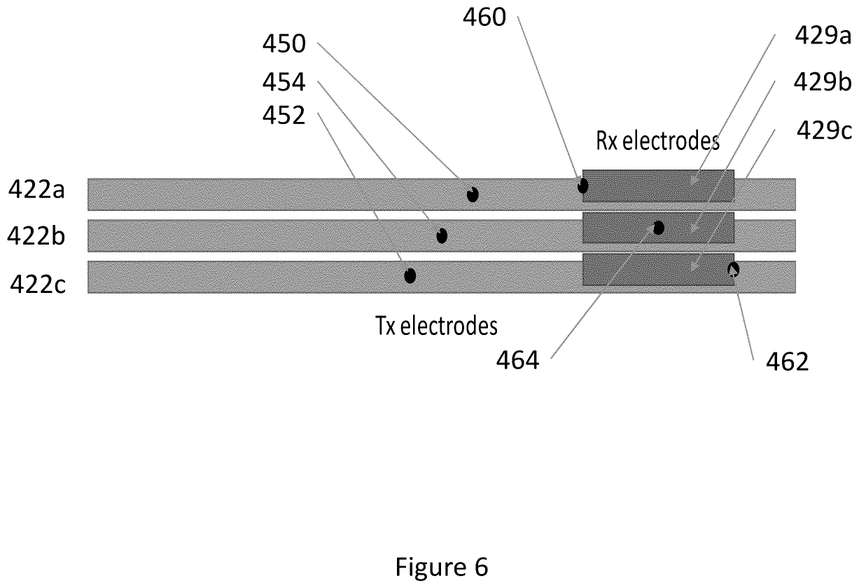

While a particular arrangement of connection points has been illustrated, one of skill in the art will appreciate other configurations are possible. For example, the receiver and transmitter may comprise more than two electrodes. Turning now to FIG. 6, another arrangement of transmitter and receiver electrodes with connections points is illustrated. In this arrangement, the transmitter resonator comprises three transmitter electrodes 422a-c and the receiver resonator comprises three receiver electrodes 429a-c.

The connection points for wires to the inverter 216 are points 450, 454, 452 to transmitter electrodes 422a-c, respectively. The points 450, 452 are laterally offset on opposite longitudinal sides of the central axis or midpoint of the transmitter electrodes 422a-c as described with respect to FIG. 3. The additional point 454 is at the central midpoint of the transmitter electrodes 422a-c. Specifically, the point 454 is at the midpoint of middle transmitter electrode 422b.

The connection points to wires to the rectifier 224 are points 460, 464, 462 to receiver electrodes 429a-c, respectively. The points 460, 462 are laterally offset on opposite longitudinal sides of the central axis or midpoint of the transmitter electrodes 429a-c as described with respect to FIG. 3. The additional point 464 is at the central midpoint of the receiver electrodes 429a-c. Specifically, the point 464 is at the midpoint of middle receiver electrode 429b.

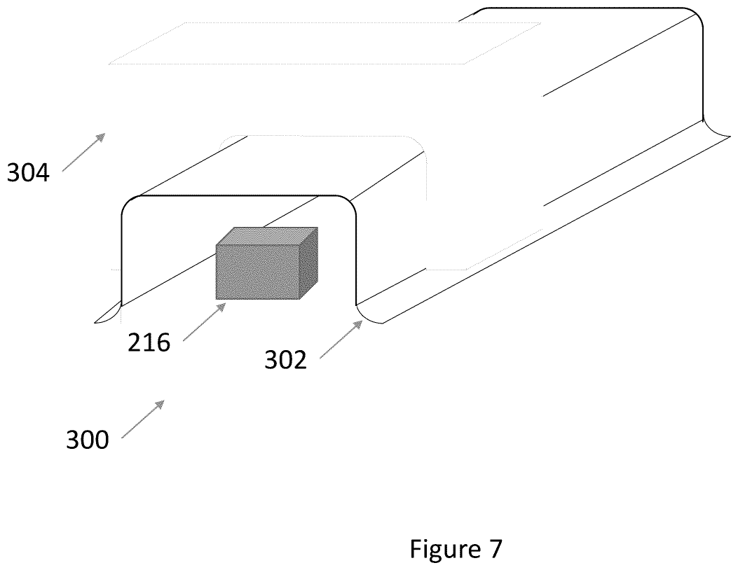

This approach to connection points could be extended to any number of transmitter/receiver electrodes where and even number of electrodes have offset connection which when summed together equal zero. If an odd number of electrodes are present, then one electrode has a connection point at the midpoint. Returning now to FIG. 2, the transmitter electrodes 222, receiver electrodes 229 and rectifier 224 are all integrated in a rail as indicated by the dotted line in FIG. 2. A rail enclosure 300 containing these various elements is illustrated in FIG. 7. The rail enclosure 300 comprises a transmitter rail 302 which forms a transmitter electrode 222, and a receiver rail 304 which forms the receiver electrode 229. The receiver rail 304 is shaped and adapted to fit around the transmitter rail 302 such that the receiver rail 304 is movable along the transmitter rail 302. The receiver rail 304 may move along the length of the transmitter rail 302 with power being transmitter from the transmitter to the receiver throughout the range of motion of the receiver rail 304.

The transmitter rail 302 may form a housing or enclosure for at least some of the components of a transmitter of a wireless power transfer system. As illustrated in FIG. 7, the inverter 216 may be within the transmitter rail 302. Additionally, the receiver rail 304 may form a housing or enclosure for at least some of the components of a receiver of the system. Specifically, the rectifier 224 may be within the receiver rail 304.

While not illustrated in FIG. 7, the terminal connections illustrated in FIG. 3 are present in the rail enclosure 300. Specifically, the inverter 216 is electrically connected to the transmitter rail 302 in the manner described, i.e., at a point offset (e.g., 250) from a longitudinal centre of the transmitter rail 302. The inverter 216 is also electrically connected to a second transmitter (not shown). Similarly, the rectifier 224 is electrically connected to an endpoint of the receiver rail 304.

During operation, the receiver rail 304 moves along the length of the transmitter rail 302 while power is transmitted from the transmitter rail 302 to the receiver rail 304. Electrical components connected to the receiver rail 304 are powered by the transferred power. Such an arrangement may be used in a vehicle with a seat moving along a floor rail. The seat may include powered components. The floor rail may correspond to the transmitter rail 302 while the seat may be affixed to the receiver rail 304. The electrical components may be powered through the entire range of motion of the receiver rail 304 along the transmitter rail 302. As the terminal connections are arranged in the manner described, power transfer efficiency may be maximized through this range of motion while not requiring lengthy wires for terminal connections at the end-points of the rails which could result in electrical losses.

While the example of a seat moving along a floor rail has been described, other use-cases are possible. For example, the described arrangement may be used sliding doors, a sun or moon-roof of a vehicle, a storage container having a sliding door, or other similar structures.

Only a portion of the rail enclosure 300 is illustrated in FIG. 7. Specifically, a single transmitter rail 302 and a single receiver rail 304. One of skill in the art will appreciate the rail enclosure 300 further includes another transmitter rail 302 and additional receiver rails 304.

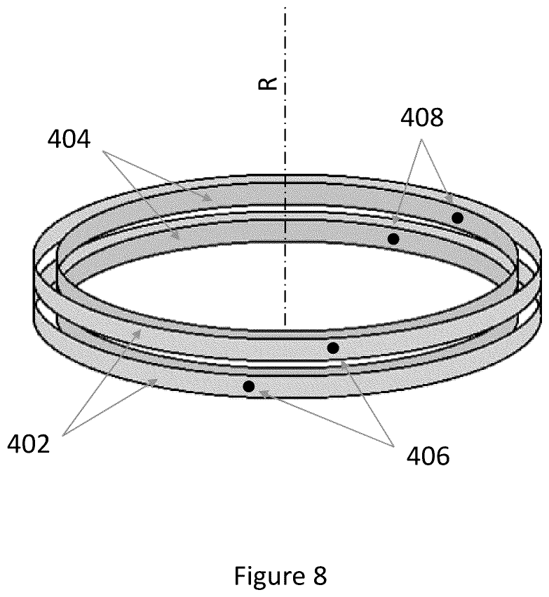

Turning now to FIG. 8, a perspective view of a portion of another embodiment of the wireless power transfer system 200. Only the transmitter electrodes and the receiver electrodes of a wireless power transfer system are illustrated. Other elements of the system are the same as the described wireless power transfer system 200 unless otherwise stated.

In this embodiment, the transmitter comprises transmitter electrodes 402 and the receiver comprises receiver electrodes 404. The transmitter electrodes 402 are concentric in the rotational axis R (shown in broken lines) as are the receiver electrodes 404. The electrodes 402, 404 are cylindrical. The transmitter electrodes 402 take the form of two rings. Similarly, the receiver electrodes 404 take the form of two rings. The receiver electrodes 404 are positioned within volume defined by the transmitter electrodes 402. The electrodes 402, 404 may be rotating, i.e., the system may be a rotating system. The transmitter electrodes 402 are of equal size and are separated by a separation distance in the y axis. The receiver electrodes 404 are of equal size and are separated by a separation distance in the y axis which is the same as the separation distance between the transmitter electrodes 402. The receiver electrodes 404 have a smaller diameter than the transmitter electrodes 402. In this embodiment, the receiver electrodes 404 rotate about the rotational axis R while the transmitter electrodes 402 remain stationary.

The transmitter terminals 406 are shown with a small offset on the positive slope, i.e., the line connecting the terminals has a positive slope. The transmitter terminals 406 may have a larger or smaller offset on the positive or negative slope, or no offset.

The receiver terminals 408 are shown with a small offset on the negative slope. The receiver terminals 408 may have a larger or smaller offset on the positive or negative slope, or no offset. The receiver terminals 408 may have a different offset from the transmitter terminals 406.

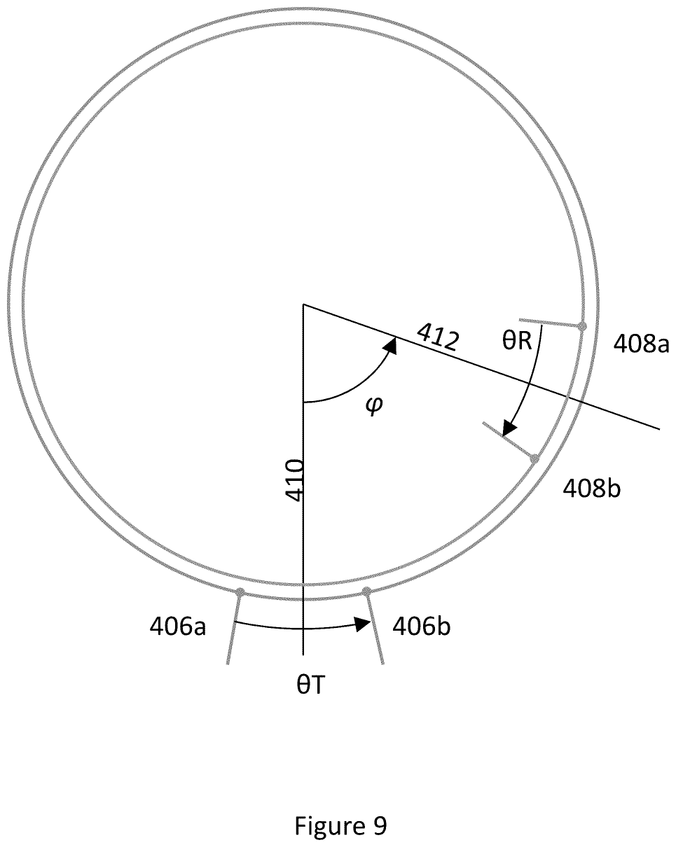

The relative positions of the terminals 406, 408 along the electrodes 402, 404 may be described by angular offsets. The angles which define the terminals 406, 408 positions are illustrated in FIG. 9.

The bottom transmitter terminal 406a, i.e., the terminal on the bottom transmitter electrode 402, is offset from the top transmitter terminal 406b, i.e., the terminal on the top transmitter electrode 402, by a transmitter terminal offset angle θT. The transmitter terminal offset θT is positive indicating an offset on the positive slope.

The bottom receiver terminal 408a, i.e., the terminal on the bottom receiver electrode 404, is offset from the top receiver terminal 408b, i.e., the terminal on the top receiver electrode 404, by a receiver terminal offset angle θR. The receiver terminal offset angle θR is negative indicating an offset on the negative slope. As such, the slopes are opposed. The angles are defined this way for convenience.

For the rotational system with two transmitter electrodes 402, the transmitter terminals 406 are symmetrical about the transmitter radial axis 410. Likewise, for the rotational system with two receiver electrodes 404, the receiver terminals 408 are symmetrical about the receiver radial axis 412. The position of receiver may be defined as the angle φ from the transmitter radial axis 410 to the receiver radial axis 412.

Each individual feature described herein is disclosed in isolation and any combination of two or more features is disclosed to the extent that such features or combinations are capable of being carried out based on the present specification as a whole in the light of the common general knowledge of one of skill in the art, irrespective of whether such features or combination of features solve any problems disclosed herein, and without limitation to the scope of the claims. Aspects of the disclosure may consist of any such individual feature or combination of features. In view of the foregoing description, it will be evident to one of skill in the art that various modifications may be made within the scope of the disclosure.

It should be understood that the examples provided are merely exemplary of the present disclosure, and that various modifications may be made thereto.

1. A wireless power transfer system comprising:
a transmitter comprising a transmitter resonator comprising a plurality of one-dimensional transmitter electrodes, and an inverter; and
a receiver comprising a receiver resonator comprising a plurality of one-dimensional receiver electrodes, and a rectifier,
the inverter electrically connected to each of the transmitter electrodes, the inverter electrically connected at offset points on the transmitter electrodes, and
the rectifier electrically connected to each of the receiver electrodes, the rectifier electrically connected at offset points on the receiver electrodes.

2. The system of claim 1, wherein the transmitter and receiver electrodes are longitudinally parallel.

3. The system of claim 1, wherein the points on the transmitter electrodes form a first line and the points on the receiver electrodes form a second line, wherein the first line has one of a positive and a negative slope, and the second line has the other of a positive and a negative slope.

4. The system of claim 1, wherein at least one of:
the transmitter electrodes are concentric;
the receiver electrodes are concentric;
the transmitter electrodes comprise circular, cylindrical transmitter electrodes; and
the receiver electrodes comprise circular, cylindrical receiver electrodes.

5. A transmitter for wirelessly transferring power to a receiver of a wireless power transfer system, the transmitter comprising a resonator comprising a plurality of one-dimensional electrodes, and an inverter, the inverter electrically connected to each of the electrodes, the inverter electrically connected at offset points on the electrodes.

6. The transmitter of claim 5, the inverter electrically connected at centrally offset points on the electrodes.

7. The transmitter of claim 5, wherein the points are offset from a central axis.

8. The transmitter of claim 7, wherein the central axis is defined by the plurality of electrodes.

9. The transmitter of claim 7, wherein the central axis is perpendicular to longitudinal axis of the plurality of electrodes.

10. The transmitter of claim 7, wherein the points are offset on opposing sides of the central axis.

11. The transmitter of claim 5, wherein the points are offset from each other.

12. The transmitter of claim 5, wherein terminals of the inverter are electrically connected to the electrodes.

13. The transmitter of claim 5, wherein the plurality of electrodes comprises a first electrode and a second electrode.

14. The transmitter of claim 13, wherein the inverter is electrically connected at a first point on the first electrode and a second point on the second electrode.

15. The transmitter of claim 14, wherein the first and second points are on opposite sides of a central axis of at least one of the first and second electrodes.

16. The transmitter of claim 14, wherein the first and second points are equidistant from the central axis of at least one of the first and second electrodes.

17. The transmitter of claim 5, further comprising a power source for providing a power signal, the power source electrically connected to the resonator.

18. A receiver for extracting power from a field generated by a transmitter of a wireless power transfer system, the receiver comprising a resonator comprising a plurality of one-dimensional electrodes, and a rectifier, the rectifier electrically connected to each of the electrodes, the rectifier electrically connected at offset points on the electrodes.
